(19) United States
(12) Patent Application Publication
(10) Pub. No.: US 2009/0059552 A1
(43) Pub. Date: Mar. 5, 2009

(54) CABLE SPOOL FOR USE WITH GLANDED FIBER TRUCKS

(76) Inventors: Wade WOMACK, Allen, TX (US); Joseph C. LIVINGSTON, Frisco, TX (US)

Correspondence Address: Muncy, Geissler, Olds & Lowe, PLLC, P.O. BOX 1364, FAIRFAX, VA, 22038-1364, US

(21) Appl. No.: 11/848,169

(22) Filed: Aug. 30, 2007

(51) Int. Cl. H02B 1/20; H02G 15/007

(52) U.S. Cl. 361/826; 174/135

(57) ABSTRACT

A cable gland holder includes a base member and a core for holding a plurality of cable glands. In one embodiment, a plate is removably attached to the core. In another embodiment, more than one plate is attached to the core. Each plate has a grooved edge presenting a series of grooves to which cable glands may be attached. The holder may be attached to a vertical or horizontal raceway of a network rack to assist in protecting and organizing the cables within the raceway.

### BACKGROUND OF THE INVENTION

1. Field of the Invention

The present invention relates to a management apparatus for cables. More particularly, the present invention relates to a device for holding a plurality of cables with attached cable glands for purposes of restraint and routing of cables within a network or equipment rack.

2. Description of the Related Art

Cable glands are well known in the existing arts. A cable gland is generally a structure which is mechanically fixed to an outer jacket of a cable, typically by a frictional fit, compression fit or possibly an adhesive. The cable gland also has attachment features which allow the cable gland to be attached to a secondary object, such as a housing, plate, or guide. The cable gland thereby provides strain relief to the cable. In other words, a pulling force applied to the cable's jacket will be transmitted, via the jacket, to the cable gland and hence to the secondary object (e.g., a housing or a guide). Therefore, the pulling force on the cable will not pass beyond the secondary object (e.g., to a termination of the cable, such as a plug received into a jack).

For more information regarding cable glands reference may be had to U.S. Pat. Nos. 4,030,741 and 5,405,172, which are herein incorporated by reference. Also, reference can be had to the assignee's pending U.S. patent application Ser. No. 11/828,198 entitled “Removable Cable Gland,” filed Jul. 25, 2007, and Ser. No. 11/735,585, entitled “Pre-Terminated Cable Assembly with Integrated Cable Gland and Pulling Eye/Sock,” filed Apr. 16, 2007, the entire contents of both applications are herein incorporated by reference.

FIG. 1 illustrates a network rack in accordance with the background art. The network rack includes a pair of vertical support members, such as a first support member 11 and a second support member 13. Pieces of electronic/optical equipment (not shown), such as a patch panel, power supply, memory unit or splice tray, would be connected to the first and second vertical support members 11 and 13. The pieces of equipment are connected to the vertical support members 11 and 13 by fasteners (e.g. screws) which cooperate with preformed mounting holes 15 in the first and second vertical support members 11 and 13.

The mounting holes 15 are spaced at a regular interval to align with standard spaced mounting holes in standard sized equipment. A common unit of measurement in the industry is known as the rack mounting unit (RMU). An RMU is 1.75 inches. Racks are specified as having a certain RMU capacity, such as 45 RMU. Equipment to be mounted to the rack has certain specified sizes as well. For example, a first patch panel might be 1 RMU in size (i.e. 1.75 inches), whereas a second patch panel might be 2 RMU (i.e., 3.5 inches) in size. Therefore, a 45 RMU rack could hold five of the first patch panels (5 total RMUs) along with twenty of the second sized patch panels (40 total RMUs).

A vertical cable raceway 17 is disposed adjacent to the second vertical support member 13. The raceway 17 may be attached to the second vertical support member 13 by a plurality of fasteners 16 passing through holes in the second support member 13. Cables entering and exiting the pieces of equipment extend horizontally, pass through support fingers 18, and enter the raceway 17. The middle support fingers 18 in FIG. 1 have been removed to simplify the illustration.

Inside the raceway 17, the cables often change direction to extend vertically, then change direction once more to extend horizontally before reaching another destination (e.g., exiting the raceway 17 to attach to another piece of equipment above or below the entry point to the raceway 17). Dashed line 19 in FIG. 1 illustrates one possible path for a cable. More details concerning network racks and vertical raceways can be had with reference to U.S. Pat. No. 7,119,282, which is herein incorporated by reference.

### SUMMARY OF THE INVENTION

The Applicants have appreciated one or more drawbacks associated with the designs of the prior art.

When fiber optic cables are used in conjunction with the devices of the background art, there is a risk of exceeding the minimum bend radius of the fiber optic cable at the point where the fiber optic cable transitions from the horizontal direction to the vertical direction inside the raceway. Perhaps hundreds of cables extend vertically within the raceway; during installation of a new cable and pulling the new cable through existing cables in the raceway, frictional engagement occurs between the jacket of the new cable being pulled through and the jackets of other cables existing in the raceway. The frictional resistance can cause snags and exert a pulling force on another fiber optic cable already in the raceway, causing the preexisting fiber optic cable to exceed its minimum bend radius as it passes over a support finger 18 or another cable during its transition from a horizontal travel direction to a vertical travel direction.

Applicants have also appreciated that the pulling force exerted on existing cables within the raceway as a new cable is installed may lead to momentary disconnections of existing communications channels. Many fiber optic terminations are spring loaded. In other words, a momentary tug on a fiber optic cable jacket can cause a spring-biased ferrule within a connector to unseat from a receiver in a jack. If the momentary displacement of the ferrule is sufficient (e.g., more than half a wave length), a communication channel may be interrupted, which can lead to an automatic equipment reboot, lost data, or an alarm.

Applicants have also appreciated that splice trays are often employed in network racks. A splice tray often employs a roller assembly or slide assembly to permit the tray to slide partially out of the network rack to give greater accessibility to the fiber apparatus (e.g. splices, splitters) on the tray. When a tray is slid out, the cables connected to the fiber apparatus on the tray extend out of the network rack as well, which may result in forces being applied to other cables within the raceway, as cables extend from and retract into the raceway as the tray is pulled out and pushed back into the network rack. Again, the relative movement between cables within the raceway can lead to snagging, bending of cables, and disconnection of cable connectors, as discussed above.

One of the primary purposes of the vertical cable raceway is to help in organizing cables in the network rack. By providing a narrow cabinet to one or both sides of the network rack, the cables can be routed to the sides of the equipment. Hence, the equipment is more accessible and the overall appearance is improved, which facilitates troubleshooting and adjustment of the equipment on the network rack by technicians. Applicants have appreciated that some additional organization of the cables may now be used inside of the vertical raceway in order to simplify the overall layout of the system to the benefit of technicians.

To this end, Applicants have appreciated a need in the art for a management apparatus for fiber optic cables for use in conjunction with vertical or horizontal cable raceways.

It is an object of the present invention to address one or more of the drawbacks of the background art designs and/or Applicants' appreciated needs in the art.

This and other objects are accomplished by a cable gland holder including a base member and a core for holding a plurality of cable glands. In one embodiment, a plate is removably attached to the core. In another embodiment, more than one plate is attached to the core. Each plate has a grooved edge presenting a series of grooves to which cable glands may be attached. The holder may be attached to a vertical or horizontal raceway of a network rack to assist in protecting and organizing the cables within the raceway.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of network rack with a vertical cable raceway, in accordance with the background art;

FIG. 2 is a perspective view of a network rack with a vertical cable raceway, in accordance with the present invention;

FIG. 3 is an enlarged perspective view of a cable gland holder of FIG. 2, illustrating a plate detached therefrom;

FIG. 4 is a cross sectional view taken along line IV-IV in FIG. 3;

FIG. 5 is a perspective view of a cable gland aligned for attachment to the cable gland holder;

FIG. 6 is a cross sectional view illustrating the attachment of the cable gland to the cable gland holder;

FIG. 7 is a rear view of the cable gland holder, illustrating attachment features on a backside of a base plate;

FIG. 8 is a cross sectional view of taken along line VIII-VIII in FIG. 7; and

FIG. 9 is a cross sectional view front view of the vertical cable raceway of the present invention, illustrating receiving slots for the attachment features of the base plate.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

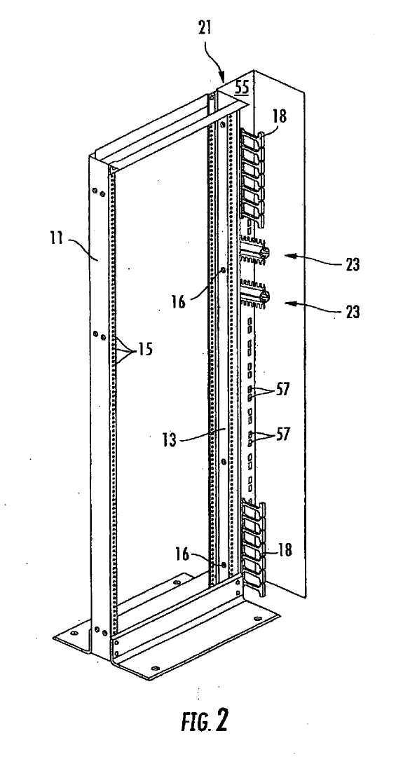

FIG. 2 is a perspective view of a network rack with a vertical cable raceway, in accordance with the present invention. The network rack includes a pair of vertical support members, such as a first support member 11 and a second support member 13. Pieces of electronic/optical equipment (not shown), such as a patch panel, power supply, memory unit or splice tray, may be connected to the first and second vertical support members 11 and 13. The pieces of equipment are connected to the vertical support members 11 and 13 by fasteners (e.g. screws) which cooperate with preformed mounting holes 15 in the first and second vertical support members 11 and 13.

The mounting holes 15 are spaced at a regular interval to align with standard spaced mounting holes in standard sized equipment. A common unit of measurement in the industry is known as the rack mounting unit (RMU). An RMU is 1.75 inches. Racks are specified as having a certain RMU capacity, such as 45 RMU. Equipment to be mounted to the rack has certain specified sizes as well. For example, a first patch panel might be 1 RMU in size (i.e. 1.75 inches), whereas a second patch panel might be 2 RMU (i.e., 3.5 inches) in size. Therefore, a 45 RMU rack could hold five of the first patch panels (5 total RMUs) along with twenty of the second sized patch panels (40 total RMUs).

A vertical cable raceway 21 is disposed adjacent to the second vertical support member 13. The raceway 21 may be attached to the second vertical support member 13 by a plurality of fasteners 16 passing through holes in the second support member 13. Cables entering and exiting the pieces of equipment extend horizontally, pass through support fingers 18 and enter the raceway 21. The middle support fingers 18 in FIG. 2 have been removed to simplify the illustration.

Inside the raceway 21, the cables often change direction to extend vertically, and then change direction once more to extend horizontally before reaching another destination (e.g. exiting the raceway 21 to attach to another piece of equipment above or below the entry point to the raceway 21). The present invention provides a cable gland holder 23 for holding a plurality of cable glands. The cable gland holder 23 may be disposed within a trough of the raceway 21, as illustrated in FIG. 2. Of course, the cable gland holder 23 may be employed in other environments.

FIG. 3 is an enlarged perspective view of the cable gland holder 23. The cable gland holder 23 includes a base member 25. The base member 25 may be formed as a generally planar member of plastic material. A core 27 protrudes from the base member 25. In a preferred embodiment, the core 27 is cylindrical in an overall shape to form a spool. The core 27 may also be formed of a plastic material, and may be bonded to the base member 25, integrally formed therewith, or removably attached thereto.

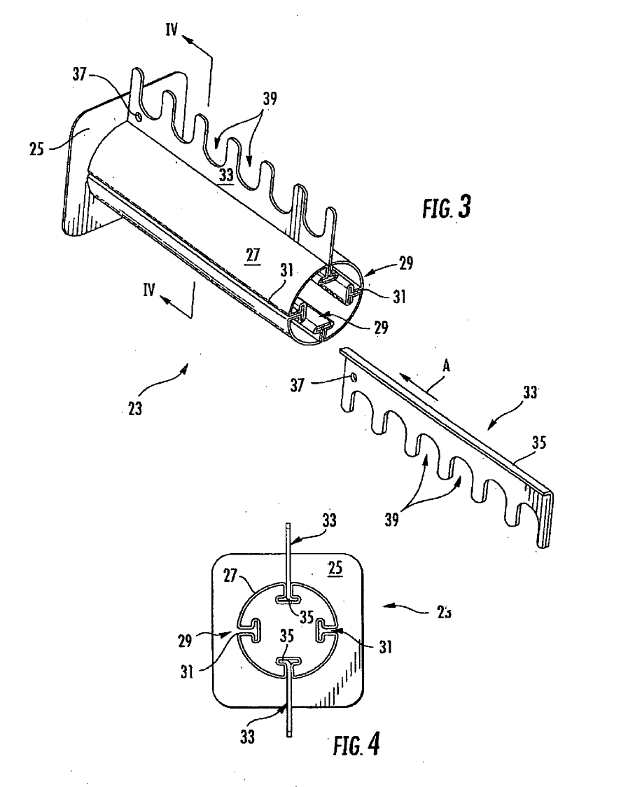

The core 27 may include a plurality of coupling features 29. Each coupling feature 29 may take the form of a slot 31 formed in the core 27. In a preferred embodiment, the slot 31 has a cross-section which is generally T-shaped. In the embodiment of FIGS. 2-6, four slots 31 are provided in a circumferentially equidistant manner around the periphery of the core 27, at about zero degrees, ninety degrees, one hundred eighty degrees and two hundred seventy degrees. Because the plastic material used to form the core 27 has a resilient property, each slot 31 may be slightly opened by applying a force and has a natural resiliency to close upon and grip an object inserted into the slot 31, which is slightly wider than the slot 31.

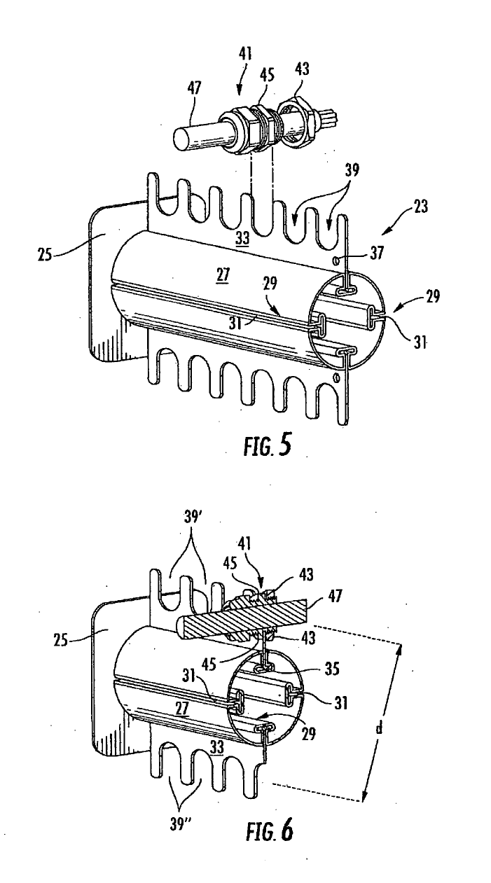

FIG. 3 also illustrates two plates 33, each having a mating feature for retention by said coupling feature 29 of said core 27. In a preferred embodiment the mating feature is a bent portion 35 along an edge of the plate 33 for sliding into the slot 31 in the direction of arrow A. Each plate 33 also has a grooved edge presenting a series of grooves 39 to receive cable glands 41 (See FIGS. 5 and 6). Although the grooved edge in FIG. 3 has been illustrated as having discontinuous curves, other types of grooved edges my be employed, such as an edge having more of a sinusoidal appearance, a square wave appearance, a saw toothed appearance, etc.

In a preferred embodiment, the plate 33 is formed of, or plated by, an electrically conductive material (e.g., the plate 33 may be formed of stainless steel). Preferably, the plate 33 includes a grounding feature, such as a through hole 37 for receiving a fastener connected to a grounding wire (not shown). By this arrangement, the plate 33 may be connected to ground and will enable grounding of armor surrounding cables.

In a first embodiment, the plate 33 is removably attached to the core 27 by a frictional engagement between a portion of the plate 33 adjacent to the bent portion 35 and the resilient side walls of the slot 31. In the embodiment illustrated in FIGS. 5 and 6, each groove 39 is sized to accept one cable gland 41, by having the grooved edge sandwiched between a retaining nut 43 and a flange 45 of the cable gland 41, as best seen in the cross sectional view of FIG. 6. Of course, if desired the grooves 39 may be formed deeper, so as to accommodate two or more cable glands.

In one embodiment, a diameter of the core 27 is approximately two inches and a length of the core 27 is approximately ten inches. However, it should be appreciated that other diameters and lengths may be used for the core 27. A primary desire is present a core diameter that is sufficient to maintain an acceptable minimum bend radius of a cable passing around the outer periphery of the core 27.

In a second optional embodiment, a distance d (see FIG. 6) between a center of the upper series of grooves 39′ and a center of the lower series of grooves 39″ is a whole number multiple of 1.75 inches or 1 RMU. By this arrangement, the cables 47, being held by the cable glands in the upper and lower series of grooves 39′ and 39″, will be spaced apart by the spool-shaped, cable gland holder 23 at regular intervals corresponding to the spacing between fingers 18 and/or the equipment within the network rack. It is also envisioned that the distance d may approximately equal a whole number multiple of one RMU or 1.75 inches, so that the cable gland holder 23 would accept cables 47 spaced apart by whole number multiples of one RMU, (e.g., 1.75 inches, 3.5 inches, 5.25 inches). Again, this is only an optional dimensional embodiment and the present invention is not limited to such a specific spatial relationship.

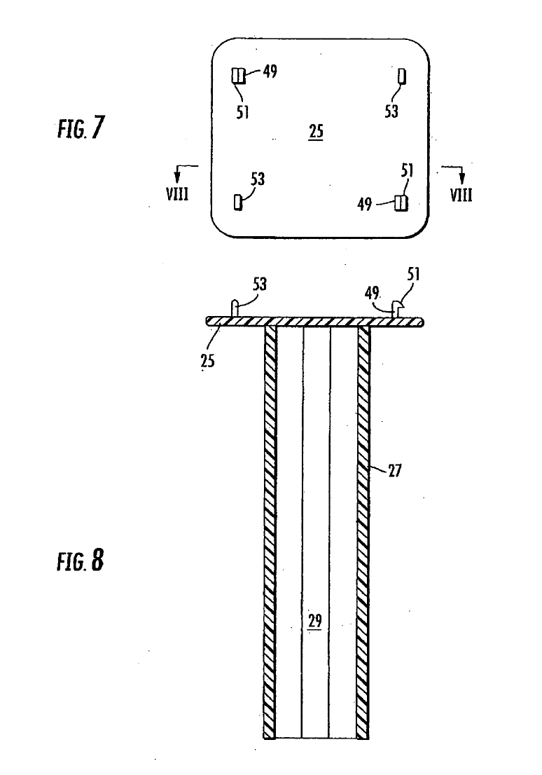

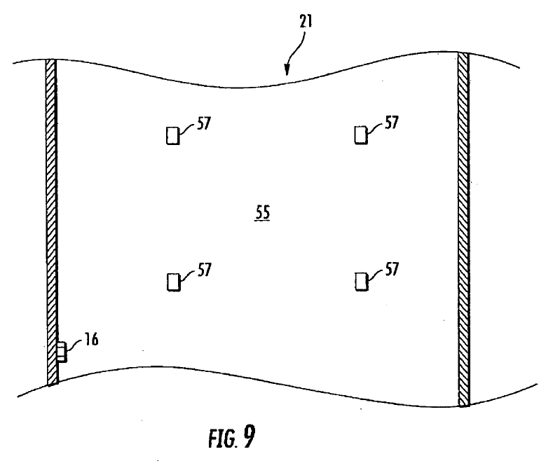

FIGS. 7 and 8 further illustrate base member 25. The base member 25 includes attachment features, which may include a plurality of latching protrusions 49, each with a latching tab 51 proximate a distal end of the latching protrusion 49. Preferably, the attachment features further include guiding protrusions 53. The guiding protrusions 53 do not include a latching tab proximate the distal end.

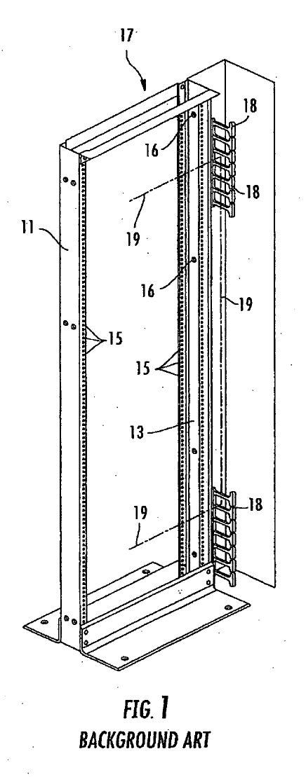

FIG. 9 is a cross sectional view of the raceway 21 of FIG. 2. The raceway 21 may be identical to the raceway 17 of the background art (FIG. 1) with the exception that the trough 55 includes a series of receiving holes 57, such as slots. The holes 57 in raceway 21 may be formed by a punching process, so that a typical trough of the background art is struck by a punching machine to form the series of holes 57.

To attach one of the base members 25 to the trough 55 of the raceway 21, a serviceman need only align the guiding protrusions 53 and the latching protrusions 49 with a desired series of holes 57 and press the base member 25 toward the trough 55. The latching tabs 51 will engage the sides of the holes 57 and cause slight deflections of the latching protrusions 49 to permit the base member 25 to move toward the trough 55. Once the base member 25 seats flush to the trough 55, the latching tabs 51 will snap past edges of the holes 57 to secure the base member 25 to the trough 55.

By the present invention, any pulling force exerted on a fiber optic cable secured within the raceway 21 to a spool-shaped core 27 will not be transmitted to the connector of that fiber optic cable. Rather the force will be transmitted via the cable gland 41, the plate 33, the core 27 and base member 25 to the trough 55. Therefore, the chance of a momentary disconnection, as discussed in the background section herein, will be greatly reduced or eliminated for that fiber optic cable. Moreover, the circular periphery of the spool-shaped core 27 will assist in preventing any exceeding of the minimum bending radius of a fiber optic cable, as the fiber optic cable transitions from its horizontal entrance orientation into the vertical raceway 21 to its vertical orientation within the vertical raceway 21, regardless of tensile forces applied to that cable, as also discussed in the background section herein. Moreover, the cables within the vertical raceway 21 may be better organized and managed for troubleshooting purposes.

Although FIG. 2 has illustrated the cable gland holders 23 of the present invention attached to a “vertical” raceway 21 attached to second vertical support member 13, the cable gland holders 23 of the present invention may be employed in other manners. For example, the cable gland holders 23 may be used in combination with a “horizontal” raceway which would be attached between the first vertical support member 11 and the second vertical support member 13.

Although one embodiment of attachment features has been illustrated in FIGS. 7-9, including two latching tabs 51 and two guiding protrusions 53 interacting with holes 57 in the trough 55, other types of attachment features may be employed. For example, the placement of the holes 57 and protrusions 49, 53 may be reversed, or more or fewer latching tabs 51 and/or guiding protrusions 53 may be employed, or the relative locations of the latching tabs 51 and guiding protrusions 53 may be modified.

In the embodiment illustrated in FIGS. 3-6, a slot-type coupling feature has been illustrated for the purpose of enabling the plate 33 to be detachably mounted to the core 27. However, in another embodiment, plates 33 could be permanent mounted to core 27 (e.g., by a bonding process). Alternatively, the plates 33 could be integrally formed with the core 27.

A flat plate or end cap may be attached to the cable gland holder 23 to cover the open end of the core 27. In FIG. 2, the end cap would cover the exposed end openings of slots 31 after the plates 33 have been installed into the slots 31. Also, the end cap may extend past the diameter of the core 27 so as to create a peripheral lip. By this arrangement, if no plates 33 were attached to the core 27, the end cap would create a retaining lip to prevent spooled cable from falling off the end of the core 27.

Although an example has been given wherein the gland 41 attaches a fiber optic cable 41 to the plate 33, it should be appreciated that the gland 41 could be used to attach another type of cable, such as a coaxial cable, a twisted pair cable, a patch cord, a security cable, etc. to the plate 33. It is also important to not excessively bend or stress other types of cables, such as coaxial cables.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A cable gland holder for holding a plurality of cable glands comprising:
a base member;
a core protruding from said base member, said core having a coupling feature; and
a plate having a mating feature retained by said coupling feature of said core, said plate also having a grooved edge presenting a series of grooves to receive cable glands.

2. The cable gland holder of claim 1, wherein said coupling feature is a slot formed in said core.

3. The cable gland holder of claim 2, wherein a cross-sectional of said slot is T-shaped.

4. The cable gland holder of claim 2, wherein said mating feature includes a bent portion along an edge of said plate for sliding into said slot.

5. The cable gland holder of claim 1, wherein said plate is removably attached to said core by a frictional engagement between said mating feature of said plate and said coupling feature of said core.

6. The cable gland holder of claim 1, wherein said core includes a plurality of coupling features, each for receiving a mating feature of a respective plate.

7. The cable gland holder of claim 1, wherein said core includes a plurality of coupling features, with a first coupling feature being located on an opposite side of said core from a second coupling feature, and wherein said plate is a first plate having a first mating feature retained by said first coupling feature of said core and wherein said grooved edge of said first plate presents a first series of grooves to receive cable glands; and further comprising:
a second plate having a second mating feature retained by said second coupling feature of said core and wherein a grooved edge of said second plate presents a second series of grooves to receive cable glands.

8. The cable gland holder of claim 1, wherein said plate is formed of, or plated by, an electrically conductive material.

9. The cable gland holder of claim 8, wherein said plate is formed of stainless steel.

10. The cable gland holder of claim 8, wherein said plate includes a grounding feature.

11. The cable gland holder of claim 10, wherein said grounding feature is a through hole for receiving a fastener connected to a grounding wire.

12. The cable gland holder of claim 1, wherein said base member includes attachment features.

13. The cable gland holder of claim 12, wherein said attachment features include at least one protrusion with a latching tab proximate a distal end of said at least one protrusion.

14. The cable gland holder of claim 1, wherein said core is cylindrical in an overall shape to form a spool.

15. The cable gland holder of claim 1, wherein said core is formed of a plastic material.

16. A cable gland holder for holding a plurality of cable glands comprising:
a base member;
a core protruding from said base member;
a first plate attached to said core, said first plate having a grooved edge presenting a first series of grooves to receive cable glands; and
a second plate attached to said core, said second plate having a grooved edge presenting a second series of grooves to receive cable glands.

17. The cable gland holder of claim 16, wherein said first plate is located on an opposite side of said core from said second plate.

18. A rack for mounting electronic equipment, said rack comprising:
a pair of vertical support members for supporting at least one electronic or optical component, wherein each of said vertical support members includes a pattern of mounting apertures repeating at a first regular interval; and
a cable raceway attached to at least one of said vertical support members, said raceway including:
a trough; and
a cable gland holder for holding a plurality of cable glands attached to said trough, said cable gland holder including:
a base member;
a core protruding from said base member, said core having a coupling feature; and
a plate having a mating feature retained by said coupling feature of said core, said plate also having a grooved edge presenting a series of grooves to receive cable glands.

19. The rack of claim 18, wherein said trough includes a plurality of receiving holes formed therein, said base member includes a plurality of protrusions, and said base member is attached to said trough via an engagement between said plurality of protrusions and said plurality of receiving holes.

20. The rack of claim 18, wherein said core includes a plurality of coupling features, with a first coupling feature being located on an opposite side of said core from a second coupling feature, and wherein said plate is a first plate having a first mating feature retained by said first coupling feature of said core and wherein said grooved edge of said first plate presents a first series of grooves to receive cable glands; and further comprising:
a second plate having a second mating feature retained by said second coupling feature of said core and wherein a grooved edge of said second plate presents a second series of grooves to receive cable glands.

23. The rack of claim 18, wherein said raceway is a vertical raceway attached to one of said vertical support members.
